(19) United States
(12) Patent Application Publication
(10) Pub. No.: US 2025/0010686 A1
(43) Pub. Date: Jan. 9, 2025

(54) VEHICLE AIR CONDITIONER

(71) Applicant: Hanon Systems, Daejeon (KR)

(72) Inventor: Jae Yeong JU, Daejeon (KR)

(21) Appl. No.: 18/712,442

(22) PCT Filed: Feb. 2, 2023
(86) PCT No.: PCT/KR2023/001498

§ 371 Date: May 22, 2024

(30) Foreign Application Priority Data
Feb. 9, 2022 (KR) 10-2022-0016877

(51) Int. Cl. B60H 1/00

(52) U.S. Cl. CPC B60H 1/00678; B60H 1/00064; B60H 2001/00092; B60H 2001/00721

(57) ABSTRACT

A vehicle air conditioner which controls the operating range and movement of a door through the feedback revision of an actuator includes an air-conditioning case having an air inflow port and an air discharge port for discharging air to the interior space of a vehicle; a cooling heat exchanger and a heating heat exchanger provided on an inner air flow path of the air-conditioning case; a temperature door rotatably between the cooling heat exchanger and the heating heat exchanger to control the discharge temperature of the air, and a rotating means for preventing a sudden change in the angle of the temperature door between cooling mode and heating mode periods.

### TECHNICAL FIELD

The present invention relates to a vehicle air conditioner, and more specifically, to a vehicle air conditioner which includes a means for driving a temperature door provided between a cooling heat exchanger and a heating heat exchanger to control the discharge temperature of air.

### BACKGROUND ART

In general, a vehicle air conditioner is an apparatus for cooling or heating the interior of the vehicle by cooling or heating through the process of introducing outdoor air into the interior of the vehicle or circulating indoor air of the vehicle. Such an air conditioner for a vehicle includes an evaporator for a cooling action and a heater core for a heating action inside an air-conditioning case, and selectively blows the air cooled by the evaporator or heated by the heater core toward parts of the interior of the vehicle.

Referring to FIG. 1, a conventional vehicle air conditioner 1 includes an air-conditioning case 10, a blower, an evaporator 2, a heater core 3, and a temperature door 15. An air inflow port 11 is formed on an inlet side of the air-conditioning case 10, and a defrost vent 12a, a face vent 12b, and floor vents 12c and 12d, the opening degree of which is adjusted by a mode door, are formed on an outlet side of the air-conditioning case. The blower is connected to the air inflow port 11 of the air-conditioning case 10 to blow indoor air or outdoor air into the air-conditioning case 10.

The evaporator 2 and the heater core 3 are sequentially provided in an inner air flow path of the air-conditioning case 10. The evaporator 2 serves as a cooling heat exchanger which cools air passing through the evaporator, and the heater core 3 serves as a heating heat exchanger which heats the air passing through the heater core. The temperature door 15 is installed between the evaporator 2 and the heater core 3, and adjusts the amount of air moving to a flow path bypassing the heater core 3 and the amount of air moving to a flow path passing through through the heater core 3, thereby controlling the temperature of the air discharged into the interior of the vehicle.

The mode door includes a vent door 17 that adjusts the opening degree of the defrost vent 12a and the face vents 12b, and a floor door 18 that adjusts the opening degree of the floor vents 12c and 12d. The temperature door 15 and the mode door are connected to an actuator installed on the outside of the air-conditioning case 10 to rotate, thereby adjusting the opening degree of cold and warm air flow paths or adjusting the opening degree of flow paths leading to each of the vents 12a to 12d.

Referring to FIGS. 2 and 3, the temperature door 15 rotates by a power transmission means installed outside the air-conditioning case 10. The power transmission means includes a lever 20 and an arm 30 that transmit rotational power of the actuator to the temperature door 15. A rotary shaft 35 of the temperature door 15 is coupled to a shaft hole 32 formed on one side of the arm 30.

A pin 31 is protrudingly formed on the other side of the arm 30, and is slidably connected along a slot 21 formed in the lever 20. The lever 20 has a coupling hole 22 which is coupled to the driving shaft of the actuator, and as the lever 20 rotates by the rotation of the driving shaft of the actuator and the pin 31 slides along the slot 21, the arm 30 is rotated, and the temperature door 15 is also rotated around the rotary shaft 35.

The drive structure of the conventional temperature door 15 requires a mold modification since the slot 21 must be changed to adjust the movement of the door. Furthermore, since the form of the slot is limited to the temperature control characteristics of one type of a vehicle, it is impossible to apply the slot to other types of vehicles. Additionally, the drive structure of the conventional temperature door has several disadvantages in that shape of the slot transition sections may is more likely to generate various noises, and it is difficult to predict such noises before actual product testing.

Moreover, as illustrated in FIG. 3, the drive structure of the conventional temperature door 15 generates large noises particularly at the sharp transition sections (C). Additionally, there is a problem of shaking and vibration of the door depending on the position of the door due to wind pressure. Furthermore, there is a limitation in the maximum operational range of the door, and there is critical points of the slot, resulting in the operational angle of the temperature door 15 typically being set to less than 100°.

### DISCLOSURE

### Technical Problem

Accordingly, the present invention has been made in view of the above-mentioned problems occurring in the related art, and it is an object of the present invention to provide a vehicle air conditioner which can control the operational range and movement of a door through a feedback revision of an actuator, can be applied to various types of vehicles without modification to a mold, and can expand the operational range of the door by reducing the structural limitations compared to the slot type.

### Technical Solution

To accomplish the above-mentioned objects, according to the present invention, there is provided a vehicle air conditioner, which includes an air-conditioning case having an air inflow port formed on one side thereof and an air discharge port formed on the other side to discharge air to an interior space of a vehicle, a cooling heat exchanger and a heating heat exchanger provided on an inner air flow path of the air-conditioning case, and a temperature door rotatably provided between the cooling heat exchanger and the heating heat exchanger to control the discharge temperature of the air, the vehicle air conditioner comprising: a driving unit for rotating the temperature door, wherein the driving unit includes a gear part and an actuator; and a rotating means provided on the gear part to prevent noise caused by a sudden angle change of the temperature door.

The rotating means includes: a first gear part which is coupled to a driving shaft; and a second gear part which meshes with the first gear part and is coupled to a rotary shaft of the temperature door.

The first gear part and the second gear part are formed in an asymmetric shape.

The rotating means continuously drives a rotational angle of the temperature door, which rotates between a cooling area and a heating area, in all sections.

At least one of the first gear part and the second gear part is formed such that the distance from the rotary shaft to the gear end varies in the circumferential direction.

At least one of the first gear part and the second gear part is formed such that the distance from the rotary shaft to the gear end either gradually increases or decreases in the circumferential direction.

The first gear part is formed such that the distance from the rotary shaft to the gear end gradually decreases when rotating in one direction, and the second gear part is formed such that the distance from the rotary shaft to the gear end gradually increases when rotating in one direction.

In the cooling area, the distance from the rotary shaft of the second gear part to the gear end is formed to be longer than that of the first gear part, and in the heating area, the distance from the rotary shaft of the first gear part to the gear end is formed to be longer than that of the second gear part.

In the cooling area, the second gear part is formed longer so that the gear ratio between the first gear part and the second gear part becomes 1:1+α, and in the heating area, the first gear part is formed longer so that the gear ratio between the first gear part and the second gear part becomes 1+α:1.

In the cooling area, the rotational angle of the second gear part is controlled to be greater than that of the first gear part, and in the heating area, the rotational angle of the second gear part is controlled to be smaller than that of the first gear part, such that the air temperature control in the heating area is more precise than the air temperature control in the cooling area.

In addition, when the temperature door opens a warm air flow path in the heating area, the wind pressure of the air passing through the cooling heat exchanger and heading upwards is greater than the wind pressure acting on the temperature door in the cooling area.

### Advantageous Effect

The vehicle air conditioner according to the present invention can effectively control the operational range and movement of the temperature door according to the feedback settings of the actuator through optimization of the shapes of the first gear part and the second gear part. Moreover, the vehicle air conditioner according to the present invention can control the operational range and movement of the temperature door through the feedback revision of the actuator during the development of the vehicle type, thereby allowing application of existing specifications without a mold modification, and efficiently controlling the operational angle of the temperature door.

In addition, the vehicle air conditioner according to the present invention allows the operational range of the temperature door to be set above a predetermined angle since reducing structural limitations compared to the conventional slot-type power transmission structure. Furthermore, the vehicle air conditioner according to the present invention can more precisely control the movement of the temperature door in the heating area compared to the cooling area, thereby effectively overcoming the difficulty in temperature control that can arise due to high wind pressure in the heating area, and effectively preventing shaking and vibration of the temperature door.

### DESCRIPTION OF DRAWINGS

FIG. 1 is a sectional view illustrating a conventional vehicle air conditioner.

FIG. 2 illustrates a power transmission means of the conventional vehicle air conditioner.

FIG. 3 is a perspective view illustrating a lever and an arm of the conventional air conditioner.

FIG. 4 is a sectional view illustrating a vehicle air conditioner according to an embodiment of the present invention.

FIG. 5 illustrates a power transmission means according to an embodiment of the present invention.

FIG. 6 illustrates a first gear part and a second gear part according to an embodiment of the present invention.

FIG. 7 illustrates an operational example of a rotating means in a cooling area according to an embodiment of the present invention.

FIG. 8 illustrates an operational example of the rotating means in a heating area according to an embodiment of the present invention.

FIG. 9 is a graph illustrating an operational angle of a temperature door by driving stages.

FIG. 10 illustrates the force direction of the power transmission means of the conventional vehicle air conditioner with the force direction of the power transmission means of the vehicle air conditioner according to the present invention.

FIG. 11 is a graph comparing the operational angle of the temperature door according to a rotational angle of an actuator according to a first embodiment of the present invention with that of the conventional art.

FIG. 12 is a graph comparing the operational angle of the temperature door according to a rotational angle of an actuator according to a second embodiment of the present invention with that of the conventional art.

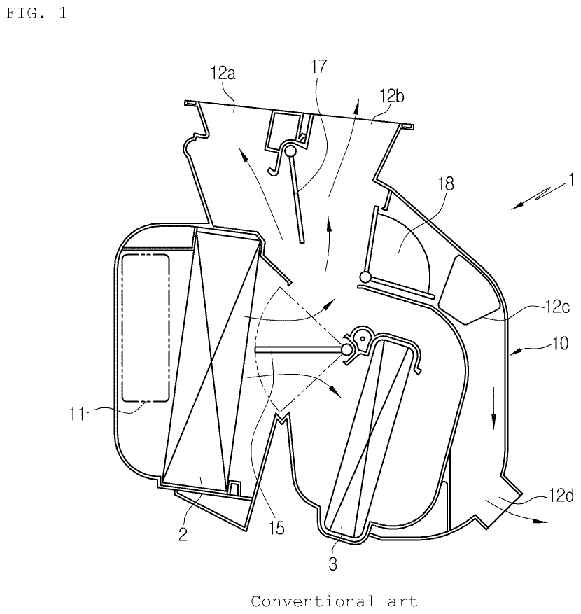

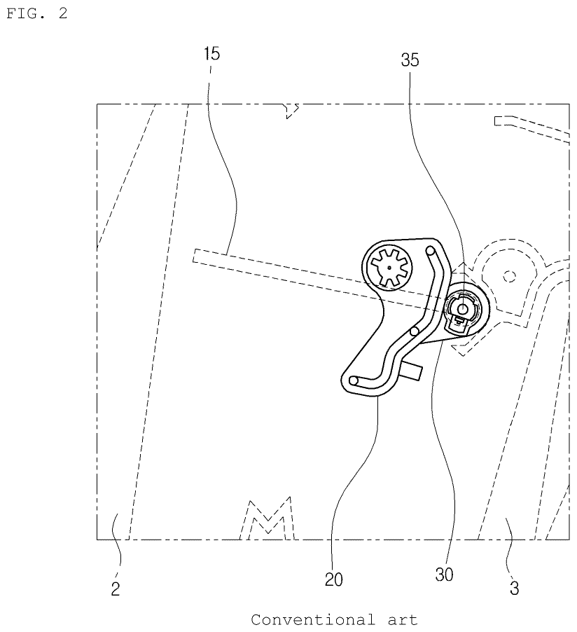

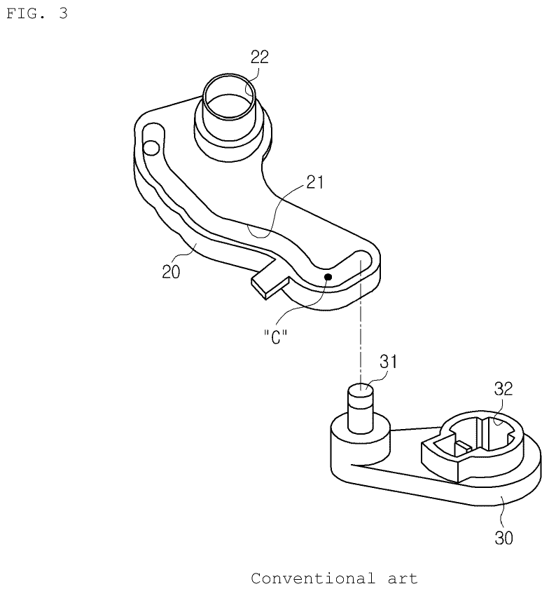

### MODE FOR INVENTION

Hereinafter, a technical configuration of a vehicle air conditioner will be described in detail with reference to the accompanying drawings.

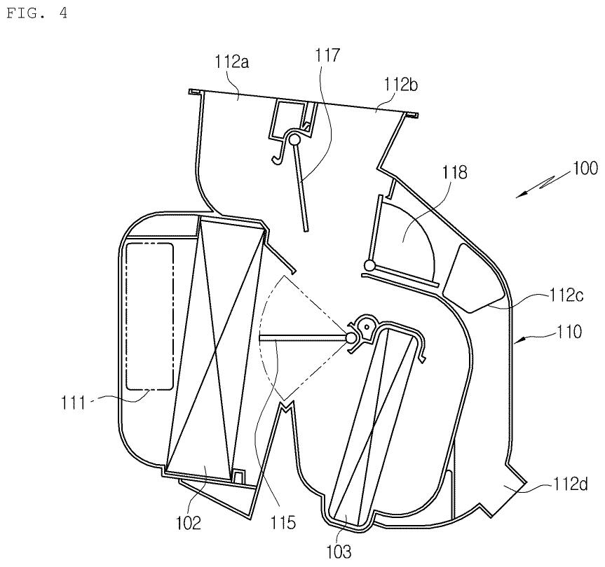

Referring to FIG. 4, a vehicle air conditioner 100 according to an embodiment of the present invention comprises an air-conditioning case 110, a blower, a cooling heat exchanger, a heating heat exchanger, a temperature door 115, and a mode door.

The air-conditioning case 110 includes an air inflow port 111 formed on one side thereof, and an air discharge port formed on the other side thereof to discharge air into the interior of a vehicle. The air discharge port includes a defrost vent 112a, a face vent 112b, and floor vents 112c and 112d. Additionally, air flow paths are formed inside the air-conditioning case 110. The blower is connected to the air inflow port 111 to blow indoor air or outdoor air into the air-conditioning case 110.

The cooling heat exchanger and the heating heat exchanger are sequentially provided in an inner air flow path of the air-conditioning case 110 in an air flow direction. The cooling heat exchanger is an evaporator 102 which cools the air passing through the cooling heat exchanger, and the heating heat exchanger is a heater core 103, which heats the air passing through the heating heat exchanger.

The temperature door 115 is rotatably installed between the evaporator 102 and the heater core 103, and controls the amount of air directed to a cold air flow path bypassing the heater core 103 and a warm air flow path passing through the heater core 103, thereby adjusting the discharge temperature of the air. The mode door includes a vent door 117 and a floor door 118. The vent door 117 adjusts the opening degree of the defrost vent 112a and the face vent 112b, and the floor door 118 adjusts the opening degree of the floor vents 112c and 112d.

The vehicle air conditioner 100 according to an embodiment of the present invention includes a driving unit. The driving unit is to rotate the temperature door 115, and includes a gear part and an actuator. The gear part includes a rotating means to prevent noise due to sudden angle changes of the temperature door 115.

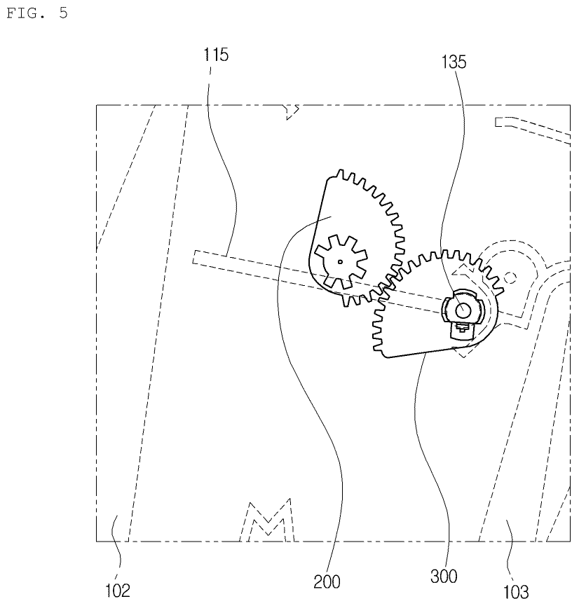

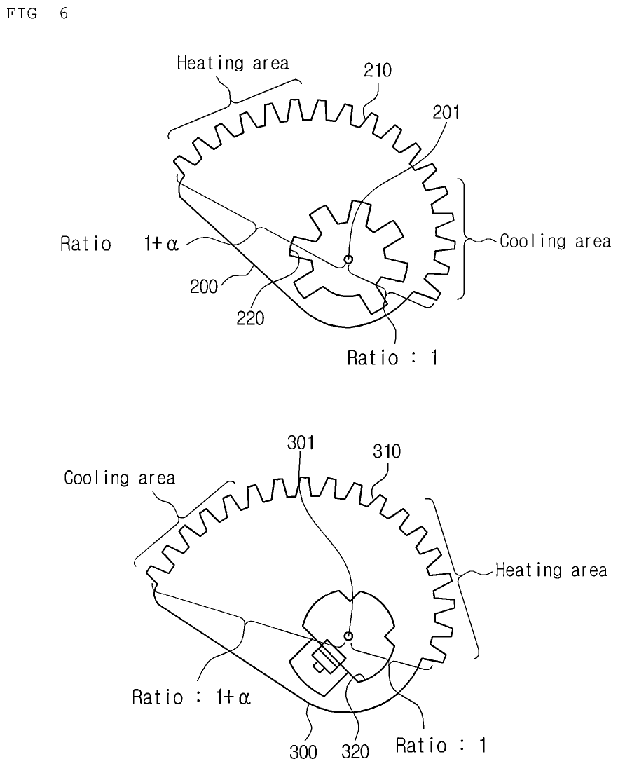

That is, referring to FIGS. 5 and 6, the vehicle air conditioner 100 according to an embodiment of the present invention includes a power p transmission means. The power transmission means is provided on the outside of the air-conditioning case 110, and connects a power source and the temperature door 115 to transmit driving power to the temperature door 115. The power source may be an actuator or the like. The power transmission means includes a rotating means.

The rotating means functions to prevent sudden angle changes of the temperature door 115 between a cooling mode section and a heating mode section. In a cooling mode, the temperature door 115 rotates in the counterclockwise direction to close the warm air flow path leading to the heater core 103 and open the cold air flow path bypassing the heater core 103. In a heating mode, the temperature door 115 rotates in the clockwise direction to open the warm air flow path leading to the heater core 103 and close the cold air flow path bypassing the heater core 103.

The rotating means includes a first gear part 200 and a second gear part 300. The first gear part 200 is coupled to a driving shaft, and the second gear part 300 meshes with the first gear part 200 and is coupled to a rotary shaft 135 of the temperature door 115. The driving shaft coupled to the first gear part 200 is a rotary shaft of the actuator.

The first gear part 200 includes a plurality of gear teeth 210 and a driving shaft coupling hole 220 for coupling with the driving shaft. The first gear part 200 rotates around the driving shaft coupled to the driving shaft coupling hole 220. The second gear part 300 includes a plurality of gear teeth 310 and a rotary shaft coupling hole 320 for coupling with the rotary shaft 135 of the temperature door 115. The second gear part 300 rotates around the rotary shaft 135 of the temperature door 115 coupled to the rotary shaft coupling hole 320.

Particularly, the first gear part 200 and the second gear part 300 are formed in an asymmetric shape. That is, the rotating means continuously drives the rotational angle of the temperature door 115, which rotates between the cooling area and the heating area, in all sections. That is, if a cam is used when the temperature door 115 moves from the cooling area to the heating area, the rotational angle may be suddenly changed in a specific section, but the present invention achieves continuous operation without sudden changes of the temperature door 115 through the configuration of the gear parts. Therefore, the temperature door 115 rotates consistently in all sections between the cooling area and the heating area, so prevents sudden angle changes of the door, thereby avoiding the generation of various noises such as “clunk,” “bump,” and “bang”.

At least one of the first gear part 200 and the second gear part 300 is formed such that the distance from the rotary shaft to a gear end in the circumferential direction varies. That is, at least one of the first gear part 200 and the second gear part 300 is formed so that the distance from the rotary shaft to a gear end gradually increases or decreases in the circumferential direction.

More specifically, the first gear part 200 is formed so that the distance from the rotary shaft to a gear end gradually decreases when rotating in one direction, and the second gear part 300 is formed so that the distance from the rotary shaft to a gear end gradually increases when rotating in one direction. The distance from a rotary shaft center 201 of the first gear part 200 to the end of the gear teeth 210 varies in the circumferential direction. Additionally, the distance from a rotary shaft center 301 of the second gear part 300 to the end of the gear teeth 310 varies in the circumferential direction.

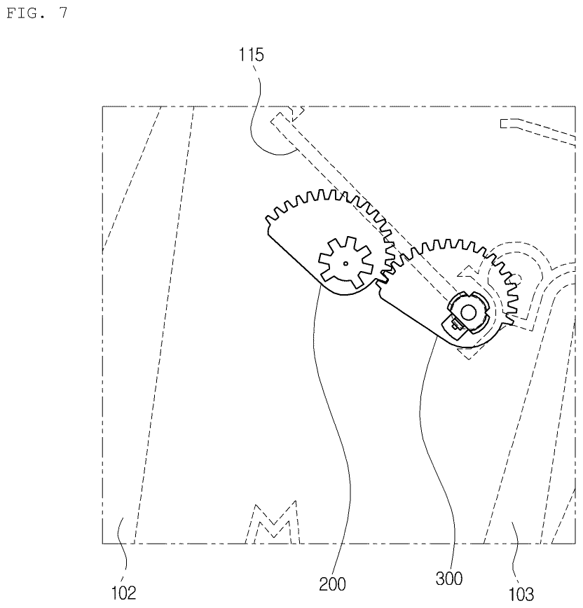

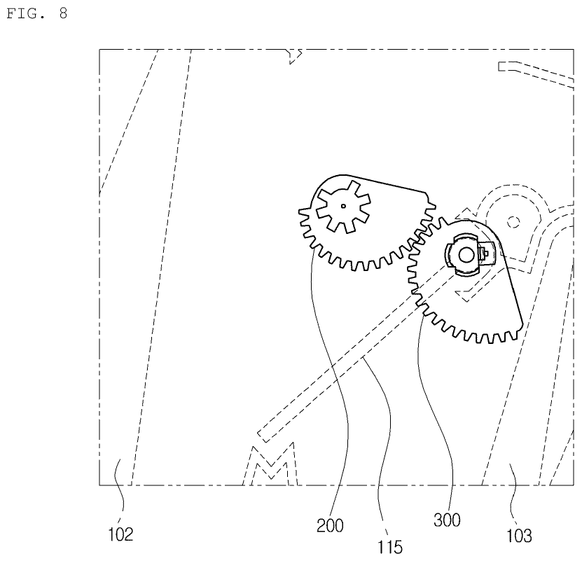

Referring to FIGS. 7 through 10, in the cooling area, the distance from the rotary shaft of the second gear part 300 to the gear end is formed to be longer than that of the first gear part 200, and in the heating area, the distance from the rotary shaft of the first gear part 200 to the gear end is formed to be longer than that of the second gear part 300.

That is, in the cooling area, the second gear part 300 is formed longer so that the gear ratio between the first gear part 200 and the second gear part 300 becomes 1:1+α, and in the heating area, the first gear part 200 is formed longer so that the gear ratio between the first gear part 200 and the second gear part 300 becomes 1+α:1.

If the conventional power transmission means is configured as a slot type, the movement of the temperature door tends to rotate suddenly due to the shape of the slot. Since the first gear part 200 and the second gear part 300 with asymmetrical shapes always operate continuously, the rotating means of the present invention can effectively prevent hitting sounds, which are chronic noise issues of the slot-type power transmission means, and various noises that can be generated due to the shape of the slot.

That is, in the cooling area, the rotational angle of the second gear part 300 is controlled to be greater than that of the first gear part 200. Moreover, in the heating area, the rotational angle of the second gear part 300 is controlled to be smaller than that of the first gear part 200. Accordingly, the air temperature control in the heating area is made more accurately than the air temperature control in the cooling area.

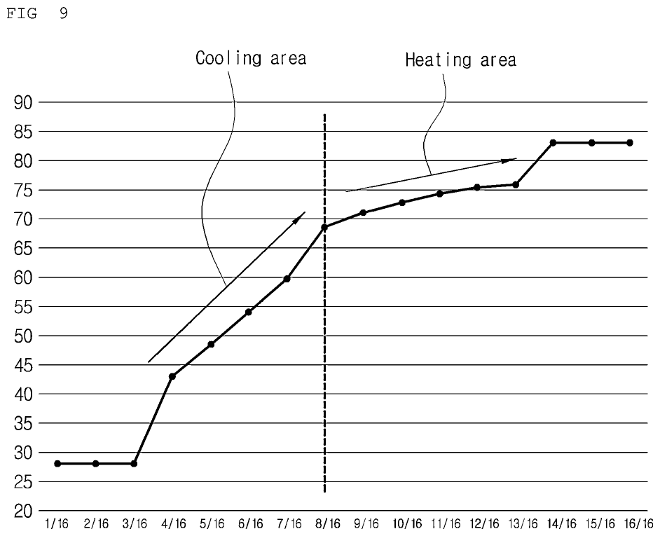

As illustrated in FIG. 9, the temperature distribution slope in the heating (Warm) area rises more gradually than that in the cooling (Cool) area. In 3/16 to 8/16 operational sections by operational stages of the temperature door, the opening amount of the temperature door is about 40°, and in 8/16 to 14/16 operational sections by operational stages of the temperature door, the opening amount of the temperature door is about 7°. Such a temperature control distribution pattern varies slightly depending on the vehicle type, but the temperature distribution slope difference between the heating and cooling areas' temperature distribution is mostly similar.

That is, the gear ratio between the actuator side and the temperature door side in the cooling area, is 1:1+α, so the rotational angle of the temperature door side can be controlled to be greater than that of the actuator side. In addition, the gear ratio between the actuator side and the temperature door side in the heating aera is 1+α:1, so the rotational angle of the temperature door side can be controlled to be relatively smaller than that of the actuator side.

Therefore, in the cooling area, the rotational angle of the second gear part 300 on the temperature door side can be controlled to be greater than the rotational angle of the first gear part 200 on the actuator side, and conversely, in the heating area, the rotational angle of the second gear part 300 on the temperature door side can be controlled to be smaller relative to the rotational angle of the first gear part 200 on the actuator side, thereby enabling precise control. As described above, through the shape optimization of the first gear part 200 and the second gear part 300, the gear ratio values can be set differently depending on the temperature distribution areas, thus realizing the temperature distribution slope of the conventional slot-type.

Additionally, through the shape optimization of the first gear part 200 and the second gear part 300 according to the present invention, it is possible to efficiently control the operational range and movement of the temperature door 115 according to the feedback settings of the actuator. In addition, during the development of vehicle types, through the actuator feedback revision, the operational range and movement of the temperature door 115 can be controlled, thereby allowing for the application of existing specifications without mold modifications and controlling the operational angle of the temperature door 115.

As illustrated in FIG. 6, the gear ratio of the first gear part 200 and the second gear part 300 variably changes from 1:1+α to 1+α:1 toward the heating area from the cooling area. Consequently, through the shape optimization of the first gear part 200 and the second gear part 300 according to the present invention, the operational range of the temperature door 115 can be set to a predetermined angle or more (e.g., 100° or more) compared to the conventional slot-type power transmission structure.

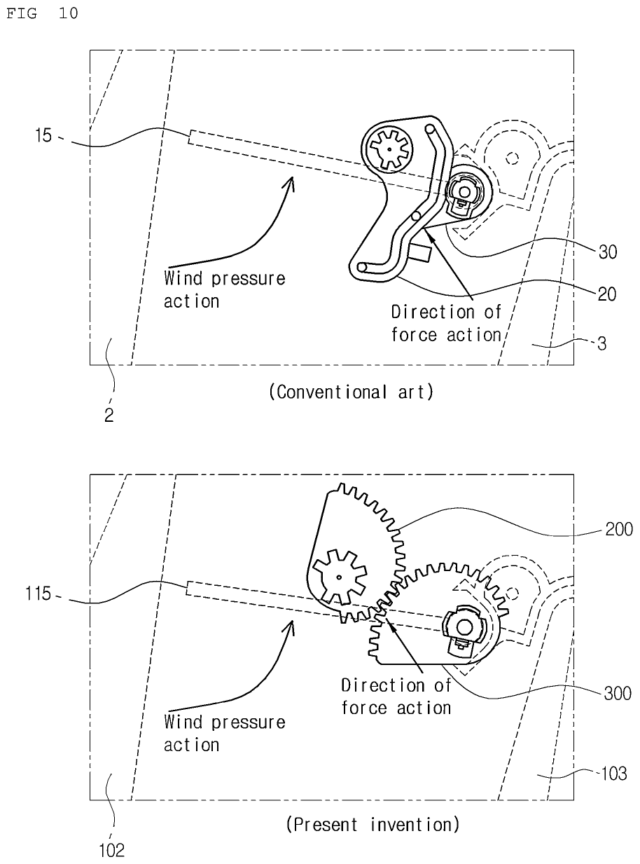

Meanwhile, in the heating area, when the temperature door 115 opens the warm air flow path, the wind pressure of the air passing through the evaporator 102 and heading upwards is higher than the wind pressure acting on the temperature door 115 in the cooling area. As illustrated in FIG. 10, the wind pressure acting on the temperature door 115 in the heating area is greater than that in the cooling area. Thus, the movement of the temperature door 115 in the heating area can be controlled more accurately than that of the temperature door in the cooling area, thereby effectively overcoming the difficulty in temperature control that may occur due to high wind pressure in the heating area.

Moreover, as illustrated in FIG. 10, in the conventional slot-type power transmission structure, a predetermined power or more acts on the lever 20 an the arm 30 by wind pressure applied to the temperature door 15, and only a single support part is formed due to the slot and pin structure. On the other hand, in the structure of the first gear part 200 and the second gear part 300 according to the present invention, the wind pressure applied to the temperature door 115 exerts a predetermined force on the first gear part 200 and the second gear part 300, so at least two supports are formed through the meshing structure of the gear teeth. Such a configuration effectively prevents shaking and vibration of the temperature door 115.

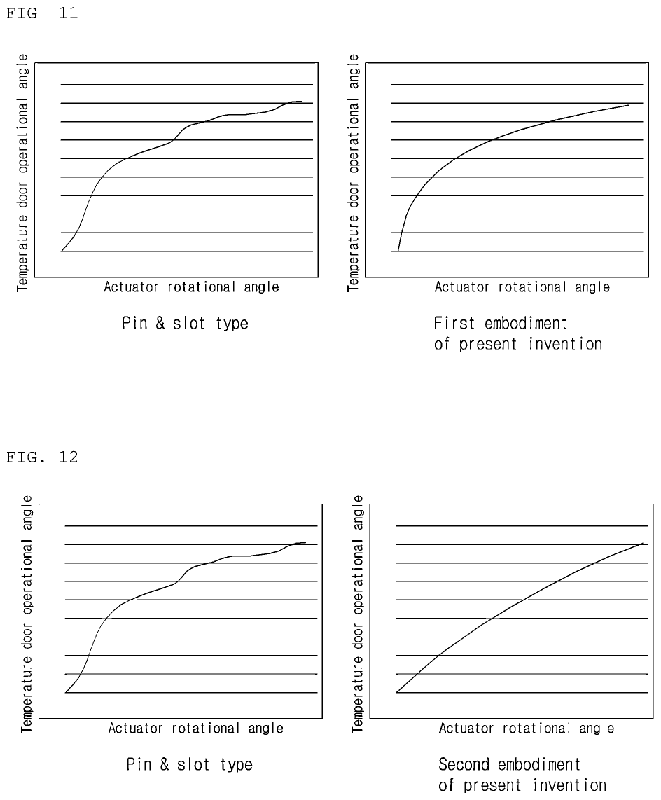

Furthermore, referring to FIGS. 11 and 12, in the conventional pin & slot type structure, there are sections where the position of the temperature door changes suddenly according to the rotational angle of the actuator. However, in the first or second embodiment of the present invention, the position of the temperature door changes smoothly according to the actuator rotational angle, so the present invention is advantageous for noise reduction. The difference in the slope of the graphs in the first and second embodiments can vary depending on how the asymmetric areas of the gear parts are set. That is, the operational angle of the temperature door depending on the actuator rotation angle can be varied according to changes in the asymmetric areas of the gears.

Although exemplary embodiments of the vehicle air conditioner according to the present invention have been described with reference to the drawings, it will be understood by those skilled in the art that various modifications and equivalents can be made without departing from the scope of the appended claims, which define the technical scope of the present invention.

1. A vehicle air conditioner, which includes an air-conditioning case having an air inflow port formed on one side thereof and an air discharge port formed on the other side to discharge air to an interior space of a vehicle, a cooling heat exchanger and a heating heat exchanger provided on an inner air flow path of the air-conditioning case, and a temperature door rotatably provided between the cooling heat exchanger and the heating heat exchanger to control the discharge temperature of the air, the vehicle air conditioner comprising:
a driving unit for rotating the temperature door, wherein the driving unit includes a gear part and an actuator; and
a rotating means provided on the gear part to prevent noise caused by a sudden angle change of the temperature door.

2. The vehicle air conditioner according to claim 1, wherein the rotating means comprises:
a first gear part which is coupled to a driving shaft; and
a second gear part which meshes with the first gear part and is coupled to a rotary shaft of the temperature door.

3. The vehicle air conditioner according to claim 2, wherein the first gear part and the second gear part are formed in an asymmetric shape.

4. The vehicle air conditioner according to claim 2, wherein the rotating means continuously drives a rotational angle of the temperature door, which rotates between a cooling area and a heating area, in all sections.

5. The vehicle air conditioner according to claim 3, wherein at least one of the first gear part and the second gear part is formed such that the distance from the rotary shaft to the gear end varies in the circumferential direction.

6. The vehicle air conditioner according to claim 5, wherein at least one of the first gear part and the second gear part is formed such that the distance from the rotary shaft to the gear end either gradually increases or decreases in the circumferential direction.

7. The vehicle air conditioner according to claim 2, wherein the first gear part is formed such that the distance from the rotary shaft to the gear end gradually decreases when rotating in one direction, and the second gear part is formed such that the distance from the rotary shaft to the gear end gradually increases when rotating in one direction.

8. The vehicle air conditioner according to claim 2, wherein in a cooling area, the distance from the rotary shaft of the second gear part to the gear end is formed to be longer than that of the first gear part, and
wherein in a heating area, the distance from the rotary shaft of the first gear part to the gear end is formed to be longer than that of the second gear part.

9. The vehicle air conditioner according to claim 8, wherein in the cooling area, the second gear part is formed longer so that the gear ratio between the first gear part and the second gear part becomes 1:1+α, and
wherein in the heating area, the first gear part is formed longer so that the gear ratio between the first gear part and the second gear part becomes 1+α:1.

10. The vehicle air conditioner according to claim 2, wherein in a cooling area, the rotational angle of the second gear part is controlled to be greater than that of the first gear part, and in a heating area, the rotational angle of the second gear part is controlled to be smaller than that of the first gear part, such that the air temperature control in the heating area is more precise than the air temperature control in the cooling area.

11. The vehicle air conditioner according to claim 10, wherein when the temperature door opens a warm air flow path in the heating area, the wind pressure of the air passing through the cooling heat exchanger and heading upwards is greater than the wind pressure acting on the temperature door in the cooling area.
